(19) United States
(12) Patent Application Publication
(10) Pub. No.: US 2025/0114941 A1
(43) Pub. Date: Apr. 10, 2025

(54) ROBOT CONTROL DEVICE

(71) Applicant: FANUC CORPORATION, Yamanashi (JP)

(72) Inventor: Shintarou HORI, Yamanashi (JP)

(21) Appl. No.: 18/729,168

(22) PCT Filed: Feb. 18, 2022
(86) PCT No.: PCT/JP2022/006768

§ 371 Date: Jul. 16, 2024

(51) Int. Cl. B25J 9/16; B25J 13/08

(52) U.S. Cl. CPC B25J 9/1676; B25J 9/1653; B25J 13/085

(57) ABSTRACT

A robot control device controlling a robot includes: an external force detection unit that detects an external force applied to the robot; and a stop control unit that switches, according to a signal indicating a state of the robot or a state of a surrounding environment of the robot, stop control for stopping the robot when the external force of a predetermined value or greater is detected by the external force detection unit.

### FIELD

An embodiment of the present invention relates to a robot control device.

### BACKGROUND

Cooperative robots, which share workspace with humans without safety fences, ensure human safety by detecting contact with humans and stopping automatically. Such a robot generally has a function of detecting an external force, and when the external force detected when a person comes into contact with the robot exceeds a predetermined threshold value, the robot stops.

PTL 1 describes that “Thus, the optimal threshold value for an external force varies depending on the situation. Therefore, it is desirable to carefully assess the situation of the robot ad the human, and change the threshold value while ensuring the safety of the human” (paragraph 0012), and further, regarding the configuration of the control device of the robot, it describes that “a control device 20 is a digital computer, and includes an external force determination condition setting unit 21 which sets, as an external force determination condition, an in-region external force determination condition when the current position of a robot 10 detected by a position detection unit 11 remains within a predetermined region, and which sets, as an external force determination condition, an out-of-region external force determination condition when the current position of the robot 10 is outside of the predetermined region.” (paragraph 0023).

PTL 2 relates to a human cooperative robot system, and describes as follows: “A human-cooperative robot system in which a robot and a human share a workspace, comprises: a detection unit that directly or indirectly detects a physical quantity which changes in response to a contact force applied to the robot when the robot comes into contact with an external environment; and a stop command unit that compares the physical quantity detected by the detection unit with each of a first threshold value and a second threshold value greater than the first threshold value, stops the robot according to a predetermined stop method when the physical quantity is equal to or greater than the first threshold value and less than the second threshold value, and stops the robot in a shorter period of time as compared with the predetermined stop method when the physical quantity is equal to or greater than the second threshold value” (claim 1).

### CITATION LIST

### Patent Literature

[PTL 1] Japanese Unexamined Patent Publication (Kokai) No. 2017-077608 A
[PTL 2] Japanese Unexamined Patent Publication (Kokai) No. 2016-064474 A

### SUMMARY

### Technical Problem

Herein, a situation in which contact between a robot and a person or object is detected by the function of detecting an external force and the robot stops, will be considered. Robots can be configured to perform a variety of tasks and to operate in a variety of working environments. In addition, the tasks and working environments of workers who work in cooperation with robots are also diverse. Therefore, when a robot detects contact with a person or object and stops, a wide range of matters must be taken into consideration, from further ensuring human safety based on risk assessment to protecting the workpiece held by the robot. There is a demand for a robot control device that can achieve more appropriate stop control by dynamically switching the stop control according to conditions when contact between a robot and a person or object is detected and the robot stops.

### Solution to Problem

One aspect of the present disclosure is a robot control device configured to control a robot and includes: an external force detection unit configured to detect an external force acting on the robot; and a stop control unit configured to switch, according to a signal indicating a state of the robot or a state of a surrounding environment of the robot, stop control for stopping the robot when an external force equal to or greater than a predetermined value is detected by the external force detection unit.

### Advantageous Effects of Invention

According to the configuration described above, more appropriate stop control can be achieved by dynamically switching the stop control according to conditions when contact between a robot and an external environment is detected and the robot is stopped.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an apparatus configuration of a robot system and functional blocks of a robot control device according to a first embodiment.

FIG. 2 is a diagram illustrating a hardware configuration example of the robot control device.

FIG. 3 is a diagram illustrating an apparatus configuration of a robot system and functional blocks of a robot control device according to a second embodiment.

FIG. 4 is a diagram illustrating an apparatus configuration of a robot system and functional blocks of a robot control device according to a third embodiment.

FIG. 5 is a diagram illustrating an apparatus configuration of a robot system and functional blocks of a robot control device according to a fourth embodiment.

FIG. 6 is a diagram illustrating an apparatus configuration of a robot system and functional blocks of a robot control device according to a fifth embodiment.

FIG. 7 is a diagram illustrating an apparatus configuration of a robot system and functional blocks of a robot control device according to a sixth embodiment.

FIG. 8 is a diagram illustrating an apparatus configuration of a robot system and functional blocks of a robot system according to a seventh embodiment.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. A form illustrated in the drawing is one example for implementing the present invention, and the present invention is not limited to the illustrated form.

Hereinafter, a robot system including a robot control device according to a first embodiment to a seventh embodiment will be described. The robot control device according to each of the embodiments is configured to achieve more appropriate stop control according to conditions by dynamically switching the stop control in response to a signal indicating a state of a robot and a state of a surrounding environment around the robot when contact between the robot and an external environment (a person, or an object in a workspace) is detected and the robot is stopped.

### First Embodiment

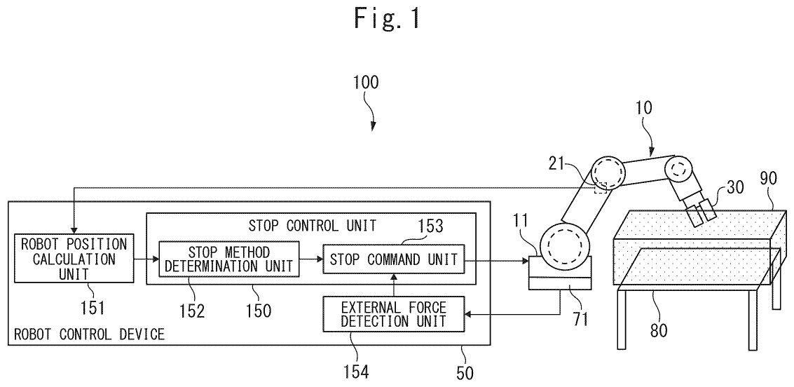

FIG. 1 is a diagram illustrating an apparatus configuration of a robot system 100 and functional blocks of a robot control device 50 according to the first embodiment. The robot system 100 is configured as a cooperative robot system in which a person and a robot share a workspace. As illustrated in FIG. 1, the robot system 100 includes a robot 10 and the robot control device 50 that controls the robot 10. The robot 10 is, for example, a vertical articulated robot as illustrated, but a robot of another type may be used. A table 80 for placing a workpiece is disposed in the workspace of the robot system 100. The robot 10 performs predetermined work on a workpiece disposed on the table 80 in cooperation with a person.

The robot 10 includes a base 11 fixed to an installation floor. The robot 10 can perform motion in such a way as to have a desired position and a desired posture by a servomotor (not illustrated) provided on each joint axis. Further, the robot 10 is provided with a position detection sensor 21 for detecting a position (rotational position) of each joint axis (FIG. 1 illustrates a part of the position detection sensors). The position detection sensor 21 is an encoder that detects a rotational position of the servomotor or an encoder that detects a rotational position of the joint axis. A signal from each position detection sensor 21 is input to the robot control device 50, and is used for calculating a position/posture and a speed of the robot 10 (a predetermined control portion of the robot 10).

The robot 10 can perform desired work by an end effector attached to a wrist portion of an arm tip. The end effector is an exchangeable external device according to use, and is, for example, a hand, a welding gun, a tool, and the like. FIG. 1 illustrates an example in which a hand 30 as one example of the end effector is used.

A force sensor 71 is attached to a lower portion of the base 11 of the robot 10. The force sensor 71 is, for example, a 6-axis force sensor. The robot control device 50 (external force detection unit 154) can detect an external force (contact force) acting on the robot 10, based on a detected value of the force sensor 71. It should be noted that the robot control device 50 can also be configured to detect an external force (contact force) acting on the robot 10 by using a torque sensor disposed on each joint axis (or at least one of the joint axes) of the robot 10.

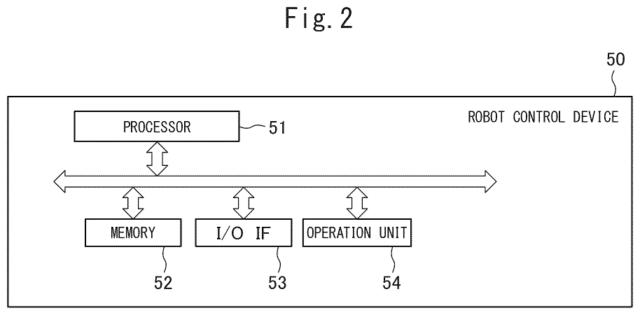

FIG. 2 illustrates a hardware configuration example of the robot control device 50. As illustrated in FIG. 2, the robot control device 50 may have a configuration as a general computer in which a memory 52 (such as a ROM, a RAM, and a non-volatile memory), an input/output interface 53, an operation unit 54 including various operation switches, and the like are connected to a processor 51 via a bus. It should be noted that the hardware configuration of the robot control device 50 is assumed to be common to the other embodiments described below.

The robot control device 50 controls motion of the robot 10 according to a control program or a command from a teaching device (not illustrated). The robot control device 50 generates a trajectory plan of a predetermined control portion (for example, a tool center point (TCP)) of the robot 10 according to a control program, and also generates a command of each axis of the robot 10 by kinematic calculation. Then, the robot control device 50 can move the predetermined control portion of the robot 10 according to the planned trajectory by executing servo control on each axis according to the command of each axis.

A specific region (hereinafter, a set region 90) is set in the workspace in which the robot system 100 is installed. The set region 90 is a region where the robot 10 performs work by using a tool (hand 30), and is particularly a region in the workspace where there is a risk for a person to be sandwiched between the robot 10 and another object. For example, information (three-dimensional positional information) about the set region 90 may be stored in advance in the memory 52 (non-volatile memory) of the robot control device 50, or may be set by a user via a setting screen (user interface) of the teaching device (not illustrated) connected to the robot control device 50.

As described below, the robot control device 50 dynamically switches, according to whether a position of the robot 10 is in the set region 90, a stop control method applied when contact between the robot 10 and an external environment (a person, or an object in a workspace) is detected. Accordingly, the robot control device 50 can set stop control when contact is detected to be appropriate according to a motion state of the robot 10.

The functional blocks of the robot control device 50 illustrated in FIG. 1 are represented with a focus on such a stop control function in the robot control device 50. As illustrated in FIG. 1, the robot control device 50 includes a robot position calculation unit 151, a stop control unit 150, and the external force detection unit 154.

The external force detection unit 154 can detect an external force (contact force) acting on the robot 10 by subtracting a weight of a workpiece held by the robot 10 and an inertial force generated by motion of the robot 10 from a detected value output from the force sensor 71. For example, the external force detection unit 154 may be configured to determine that the robot 10 comes into contact with an external environment (a person or an object) when a detected contact force is equal to or greater than a predetermined threshold value.

The robot position calculation unit 151 calculates a position of the robot 10 (predetermined movable portion), based on positional information from the position detection sensor 21 disposed on each joint axis of the robot 10. For example, a tool center point (TCP) position of the robot 10 or a tool (hand 30) position may be calculated as a position of the robot 10. The positional information is calculated as a value in a world coordinate system set for the base 11 of the robot 10. The robot position calculation unit 151 further calculates whether the position of the robot 10 is located in the set region 90, and sends a signal indicating whether the position of the robot 10 is located in the set region 90 to the stop control unit 150. In other words, the robot position calculation unit 151 sends a signal indicating a state of the robot 10 to the stop control unit 150.

For example, the robot position calculation unit 151 may determine whether the robot 10 is present in the set region 90 by comparing a calculated position of the robot 10 (such as a position of the hand 30) with positional information indicating the set region 90. Alternatively, the robot position calculation unit 151 may determine whether the robot 10 is present in the set region 90 by virtually disposing a model of the robot 10 in the workspace so as to have the calculated position and posture of the robot 10, and determining whether the model of the robot 10 interferes with the set region 90.

The stop control unit 150 switches, according to whether the robot 10 is located in the set region 90, stop control for stopping the robot 10 when contact between the robot 10 and an external environment is detected by the external force detection unit 154. As a configuration for achieving such a function, the stop control unit 150 includes a stop method determination unit 152 and a stop command unit 153.

The stop method determination unit 152 switches, depending on whether the robot 10 is within the set region 90 or outside the set region 90, a type and/or a set value of a control parameter used for the stop control when contact between the robot 10 and the external environment is detected by the external force detection unit 154. The control parameter used for the stop control may include at least one of a stop time, acceleration, a jerk, a motor current, an axis torque, and a reversal distance. It should be noted that acceleration, a jerk, a motor current (current applied to a motor of each axis), and an axis torque among the control parameters are all parameters related to force for decelerating a robot (each axis).

The stop command unit 153 sends, to the robot 10, a command for stopping the robot 10 according to the control parameter set by the stop method determination unit 152, in response to detection of contact between the robot 10 and the external environment by the external force detection unit 154.

As an exemplification, the stop method determination unit 152 sets a stop time T1 applied when the robot 10 is within the set region 90 to be shorter than a stop time T2 applied when the robot 10 is outside the set region 90. In other words, the stop method determination unit 152 sets a stop time to be T1<T2. In this case, the stop command unit 153 executes deceleration control by determining acceleration (deceleration) for stopping the robot 10 from a current speed within the stop time T1 (or T2).

With the configuration as described above, in a case where the robot 10 is within the set region 90 when contact between the robot 10 and an external environment is detected, the robot 10 can be stopped in a stop time shorter than that in a case where the robot 10 is outside the set region 90 when contact between the robot 10 and the external environment is detected, and therefore occurrence of a situation where a person is sandwiched between the robot 10 and another object in the set region 90 can be reliably avoided. On the other hand, in a case where the robot 10 is outside the set region 90 when contact between the robot 10 and an external environment is detected, the robot 10 can be stopped in a stop time longer than that in a case where the robot 10 is within the set region 90 when contact between the robot 10 and the external environment is detected, and therefore an excess load can be prevented from being imposed on the robot 10, a workpiece, and the like when the robot 10 is stopped outside the set region 90.

Further, when the robot 10 is within the set region 90, motion of reversing the robot 10 by a predetermined distance after a stop in the above-described stop time T1 may be added. In this way, a situation where a person is sandwiched between the robot 10 and another object can be more reliably avoided.

As described above, according to the first embodiment, more appropriate stop control can be achieved by dynamically switching the stop control according to conditions when contact between a robot and an external environment is detected and the robot is stopped.

### Second Embodiment

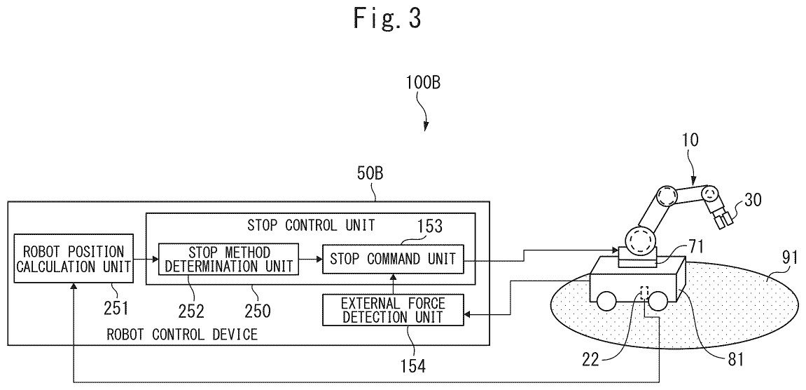

FIG. 3 illustrates an apparatus configuration of a robot system 100B including a robot control device 50B according to the second embodiment, and functional blocks of the robot control device 50B. As illustrated in FIG. 3, the robot system 100B includes a robot 10 mounted on a cart 81, and the robot control device 50B that controls the robot 10. It should be noted that, in FIG. 3, the same components as those in the first embodiment are provided with the same reference signs.

A specific region (set region 91) is set in a workspace in which the robot system 100B is installed. In the present example, the set region 91 is assumed to be a two-dimensional region set on a surface of a floor in the workspace and a region close to each object such as a pole, a peripheral device, and a structure. In other words, the set region 91 is a region where there is a risk that the robot 10 (cart 81) interferes with an object or that a person is sandwiched between the robot 10 and another object. It should be noted that the set region 91 may be stored in advance in the robot control device 50B, or may be set by a user via a setting screen (user interface) of a teaching device (not illustrated) connected to the robot control device 50B.

As described below, the robot control device 50B is configured to dynamically switch stop control when contact between the robot 10 and an external environment is detected, according to whether the robot 10 mounted on the cart 81 is within the set region 91 set in the workspace.

The functional blocks of the robot control device 50B illustrated in FIG. 3 are represented with a focus on such a stop control function in the robot control device 50B. The robot control device 50B includes a robot position calculation unit 251, a stop control unit 250, and an external force detection unit 154.

The external force detection unit 154 detects contact between the robot 10 and an external environment, based on a detected value of a force sensor 71.

The robot position calculation unit 251 detects a position of the cart 81 (for example, a central position of the cart 81), based on a signal from a position detection sensor 22 disposed on the cart 81, and uses the detected position of the cart 81 as a position of the robot 10. The position detection sensor 22 disposed on the cart 81 is, for example, a sensor that outputs a vehicle speed pulse of the cart 81, or an acceleration sensor, a gyro sensor, and the like for detecting a position. The robot position calculation unit 251 may register a position of the robot 10 (cart 81) on map data about the workspace, and always monitor the position of the robot 10 (cart 81) on the map data by using a signal from the position detection sensor 22. The robot position calculation unit 251 further calculates whether the position of the robot 10 is in the set region 91, and sends a signal indicating whether the position of the robot 10 is in the set region 91 to the stop control unit 250. In other words, the robot position calculation unit 251 sends a signal indicating a state of the robot 10 to the stop control unit 250.

For example, the robot position calculation unit 251 may determine whether the robot 10 is present in the set region 91 by comparing a position of the robot 10 with positional information indicating the set region 91. Alternatively, the robot position calculation unit 251 may determine whether the robot 10 is present in the set region 91 by virtually disposing a model of the robot 10 (including a model of the cart 81) at the position of the robot 10, and calculating whether the model is present in the set region 91.

The stop control unit 250 switches, according to whether the robot 10 is within the set region 91, stop control for stopping the robot 10 when contact between the robot 10 and the external environment is detected by the external force detection unit 154. As a configuration for achieving such a function, the stop control unit 250 includes a stop method determination unit 252 and a stop command unit 153.

The stop method determination unit 252 switches, depending on whether the robot 10 is within the set region 91 or outside the set region 91, a type and/or a set value of a control parameter used for the stop control when contact between the robot 10 and the external environment is detected by the external force detection unit 154. The control parameter used for the stop control may include at least one of a stop time, acceleration, a jerk, a motor current, an axis torque, and a reversal distance.

The stop command unit 153 sends, to the robot 10, a command for stopping the robot 10 according to the control parameter set by the stop method determination unit 252, in response to detection of contact between the robot 10 and the external environment by the external force detection unit 154.

As an exemplification, the stop method determination unit 252 sets a stop time T21 applied when the robot 10 (cart 81) is within the set region 91 to be shorter than a stop time T22 applied when the robot 10 (cart 81) is outside the set region 91. In other words, the stop method determination unit 252 sets a stop time to be T21<T22. In this case, the stop command unit 153 executes deceleration control by determining acceleration (deceleration) for stopping the robot 10 from a current speed within the stop time T21 (or T22).

With the configuration as described above, in a case where the robot 10 is within the set region 91 when contact between the robot 10 and an external environment is detected, the robot 10 can be stopped in a stop time shorter than that in a case where the robot 10 is outside the set region 91 when contact between the robot 10 and the external environment is detected, and therefore occurrence of a situation where a person is sandwiched between the robot 10 and another object in the set region 91 can be reliably avoided. On the other hand, in a case where the robot 10 is outside the set region 91 when contact between the robot 10 and an external environment is detected, the robot 10 can be stopped in a stop time longer than that in a case where the robot 10 is within the set region 91 when contact between the robot 10 and the external environment is detected, and therefore an excess load can be prevented from being imposed on the robot 10, a workpiece, and the like when the robot 10 is stopped outside the set region 91.

Further, when the robot 10 is within the set region 91, motion of reversing the robot 10 after a stop in the above-described stop time T21 may be added. In this way, a situation where a person is sandwiched between the robot 10 and another object can be more reliably avoided.

### Third Embodiment

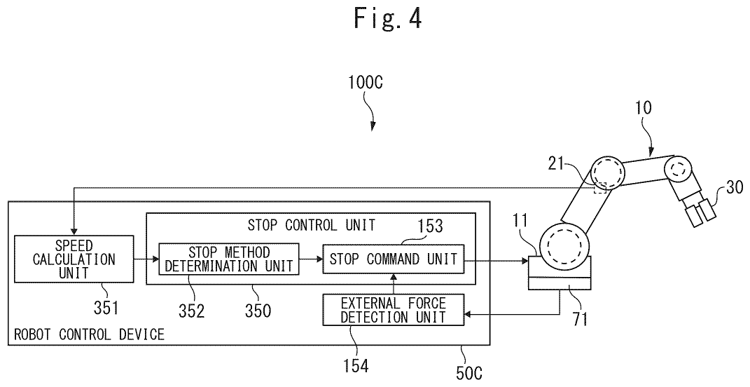

FIG. 4 illustrates an apparatus configuration of a robot system 100C including a robot control device 50C according to the third embodiment, and functional blocks of the robot control device 50C. As illustrated in FIG. 4, the robot system 100C includes a robot 10 and the robot control device 50C that controls the robot 10. The robot 10 is fixed to an installation floor.

As described below, the robot control device 50C is configured to dynamically switch stop control when contact between the robot 10 and an external environment is detected, according to a speed of the robot 10 (predetermined movable portion).

The functional blocks of the robot control device 50C illustrated in FIG. 4 are represented with a focus on such a stop control function in the robot control device 50C. The robot control device 50C includes a speed calculation unit 351, a stop control unit 350, and an external force detection unit 154.

The external force detection unit 154 detects contact between the robot 10 and an external environment, based on a detected value of a force sensor 71.

The speed calculation unit 351 calculates a speed of the robot 10 (speed of a predetermined movable portion of the robot 10), based on positional information from the position detection sensor 21 disposed on each joint axis of the robot 10. In the present embodiment, the speed calculation unit 351 is assumed to calculate a speed of a tool (hand 30) attached to an arm tip portion of the robot 10. The speed calculation unit 351 determines whether a speed of the tool is equal to or greater than a predetermined speed value, and sends, to the stop control unit 350, a signal indicating whether the speed of the tool is equal to or greater than the predetermined speed value. In other words, the speed calculation unit 351 sends a signal indicating a state of the robot 10 to the stop control unit 350.

The stop control unit 350 switches, according to whether the speed of the tool is equal to or greater than the predetermined speed value, stop control for stopping the robot 10 when contact between the robot 10 and the external environment is detected by the external force detection unit 154. As a configuration for achieving such a function, the stop control unit 350 includes a stop method determination unit 352 and a stop command unit 153.

The stop method determination unit 352 switches, between a case where the speed of the tool is equal to or greater than the predetermined speed value and a case where the speed of the tool is less than the predetermined speed value, a type and/or a set value of a control parameter used for the stop control when contact between the robot 10 and the external environment is detected by the external force detection unit 154. The control parameter used for the stop control may include at least one of a stop time, acceleration, a jerk, a motor current, an axis torque, and a reversal distance.

The stop command unit 153 sends, to the robot 10, a command for stopping the robot 10 according to the control parameter set by the stop method determination unit 352, in response to detection of contact between the robot 10 and the external environment by the external force detection unit 154.

As an exemplification, the stop method determination unit 352 sets a stop time T31 applied when the speed of the tool is equal to or greater than the predetermined speed value to be longer than a stop time T32 applied when the speed of the tool is less than the predetermined speed value.

In other words, the stop method determination unit 352 sets a stop time to be T31>T32. In this case, the stop command unit 153 executes deceleration control by determining acceleration (deceleration) for stopping the robot 10 from a current speed in the stop time T31 (or T32).

It should be noted that the predetermined speed value described above is determined in consideration of conditions such as the extent to which a load on a workpiece held by the hand 30 needs to be suppressed. For example, when there is a condition where a load on a workpiece needs to be further suppressed, the predetermined speed value may be set to a lower value.

According to the configuration as described above, it is possible to more slowly stop the robot 10 in a case where a speed of a tool is equal to or greater than a predetermined speed when contact between the robot 10 and an external environment is detected, thereby making it possible to prevent an excess load from being imposed on the robot 10 or a workpiece held by the robot 10 when the robot is stopped.

### Fourth Embodiment

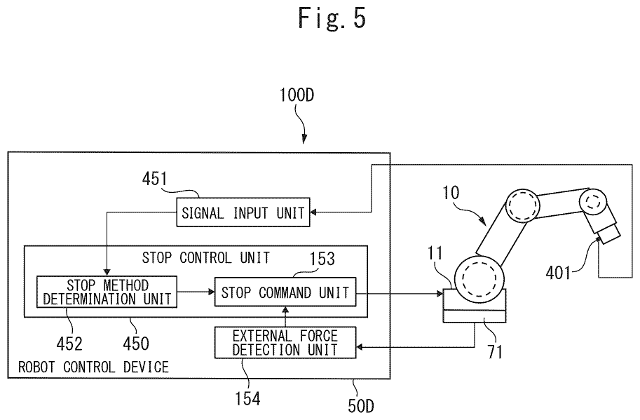

FIG. 5 illustrates an apparatus configuration of a robot system 100D including a robot control device 50D according to the fourth embodiment, and functional blocks of the robot control device 50D. As illustrated in FIG. 5, the robot system 100D includes a robot 10 and the robot control device 50D that controls the robot 10. The robot 10 is fixed to an installation floor.

In the robot system 100D, a contact detection sensor 401 is attached to a specific portion of the robot 10 so as to detect contact of a person or an object with the contact detection sensor 401. The robot control device 50D dynamically switches, according to a detection signal from the contact detection sensor 401, stop control when contact between the robot 10 and an external environment is detected.

The functional blocks of the robot control device 50D illustrated in FIG. 5 are represented with a focus on such a stop control function in the robot control device 50D. The robot control device 50D includes a signal input unit 451, a stop control unit 450, and an external force detection unit 154.

A signal from the contact detection sensor 401 is input to the signal input unit 451. As one example, a signal from the contact detection sensor 401 is a signal to be turned on when contact is detected. For example, the contact detection sensor 401 is attached to a location on the robot 10 where it is particularly undesirable for a person to touch it. In other words, in the present embodiment, a signal indicating a surrounding environment of the robot 10 is input to the stop control unit 450 via the signal input unit 451.

In the present example, the contact detection sensor 401 is attached to a vicinity (arm tip portion) of a tool. The contact detection sensor 401 may be a mechanical switch to be turned on by a press, a touch sensor, a sensor that detects a press (pressure) by an object, and the like. In order to more reliably detect contact, a plurality of the contact detection sensors 401 may be disposed.

The external force detection unit 154 detects contact between the robot 10 and an external environment, based on a detected value of a force sensor 71.

The stop control unit 450 switches, according to whether a person (or another object) is in contact with the contact detection sensor 401, stop control for stopping the robot 10 when contact between the robot 10 and the external environment is detected by the external force detection unit 154. As a configuration for achieving such a function, the stop control unit 450 includes a stop method determination unit 452 and a stop command unit 153.

The stop method determination unit 452 switches, depending on whether a person (or another object) is in contact with the contact detection sensor 401, a type and/or a set value of a control parameter used for the stop control when contact between the robot 10 and the external environment is detected by the external force detection unit 154. The control parameter used for the stop control may include at least one of a stop time, acceleration, a jerk, a motor current, an axis torque, and a reversal distance.

The stop command unit 153 sends, to the robot 10, a command for stopping the robot 10 according to the control parameter set by the stop method determination unit 452, in response to detection of contact between the robot 10 and the external environment by the external force detection unit 154.

As an exemplification, the stop method determination unit 452 sets a stop time T41 applied when contact is detected by the contact detection sensor 401 (when a signal input to the signal input unit 451 is ON) to be shorter than a stop time T42 applied when contact is not detected by the contact detection sensor 401 (when a signal input to the signal input unit 451 is OFF). In other words, the stop method determination unit 452 sets a stop time to be T41<T42. In this case, the stop command unit 153 executes deceleration control by determining acceleration (deceleration) for stopping the robot 10 from a current speed in the stop time T41 (or T42).

By setting a stop time in the stop control as described above, for example, the robot 10 is stopped in a short time when a person touches a part of the robot that should not be touched (such as an arm tip portion close to a tool), and thus the stop control for further enhancing safety of the person can be achieved.

It should be noted that the following modification example is also possible in relation to the fourth embodiment. In the present modification example, a contact detection sensor is attached to each of a plurality of different positions on the robot 10, and a signal of the contact detection sensors is input to the stop control unit 450 (stop method determination unit 452). As an exemplification, a case where a first contact detection sensor is attached to an arm tip (flange portion) of the robot 10 and a second contact detection sensor is attached to another location on the arm is assumed. It is assumed that the arm tip is the part that is most undesirable for a user to touch, and the other parts of the arm are next most undesirable for the user to touch. In this case, the stop method determination unit 452 may set a stop time to be T141<T142<T143 where a stop time when contact is detected by the first contact detection sensor is T141, a stop time when contact is detected by the second contact detection sensor is T142, and a stop time when no contact is detected by either the first contact detection sensor or the second contact detection sensor is T143. With this configuration, the stop time can be set in stages according to the degree of risk for a user.

### Fifth Embodiment

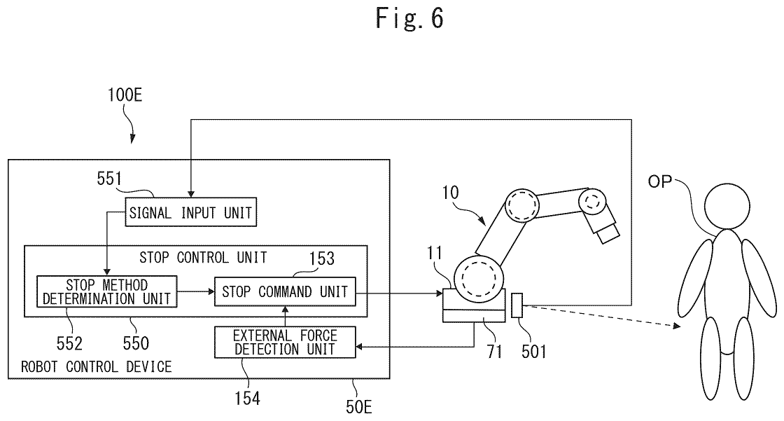

FIG. 6 illustrates an apparatus configuration of a robot system 100E including a robot control device 50E according to the fifth embodiment, and functional blocks of the robot control device 50E. As illustrated in FIG. 6, the robot system 100E includes a robot 10 and the robot control device 50E that controls the robot 10. The robot 10 is fixed to an installation floor.

In the present embodiment, a human detection sensor 501 is disposed at a predetermined position (for example, a base 11 of the robot 10) in a workspace, and whether a person OP is approaching the robot 10 is detected. The robot control device 50E is configured to dynamically switch stop control when contact between the robot 10 and an external environment is detected, depending on whether the person OP is approaching the robot 10.

The functional blocks of the robot control device 50E illustrated in FIG. 6 are represented with a focus on such a stop control function in the robot control device 50E. The robot control device 50E includes a signal input unit 551, a stop control unit 550, and an external force detection unit 154.

A signal from the human detection sensor 501 that can detect the approach of the person OP is input to the signal input unit 551. As one example, a signal from the human detection sensor 501 is a signal to be turned on when the approach of the person OP to the robot 10 is detected. In other words, in the present embodiment, a signal indicating a state of a surrounding environment of the robot 10 is input to the stop control unit 550 via the signal input unit 551.

As an exemplification, the human detection sensor 501 may output an ON signal when the person OP comes within a predetermined distance from the robot 10. For example, the human detection sensor 501 is a laser distance measuring sensor or a laser scanner that measures a distance to an approaching object by irradiation with laser light or scanning. Such a laser distance measuring sensor or a laser scanner may be disposed on the base 11 of the robot 10 or may be installed at a predetermined position in the workspace. Alternatively, a sheet-shaped sensor that outputs a signal when a person steps on it may be adopted as the human detection sensor 501. Alternatively, the human detection sensor 501 may be a sensor formed of a camera that is installed in the workspace, acquires images of an area around the robot 10, and detects the approach of a person to the robot 10 by image processing.

The external force detection unit 154 detects contact between the robot 10 and an external environment, based on a detected value of a force sensor 71.

The stop control unit 550 switches, depending on whether the approach of a person to the robot 10 is detected by the human detection sensor 501, stop control for stopping the robot 10 when contact between the robot 10 and the external environment is detected by the external force detection unit 154. As a configuration for achieving such a function, the stop control unit 550 includes a stop method determination unit 552 and a stop command unit 153.

The stop method determination unit 552 switches, depending on whether the approach of a person to the robot 10 is detected by the human detection sensor 501, a type and/or a set value of a control parameter used for the stop control when contact between the robot 10 and the external environment is detected by the external force detection unit 154. The control parameter used for the stop control may include at least one of a stop time, acceleration, a jerk, a motor current, an axis torque, and a reversal distance.

The stop command unit 153 sends, to the robot 10, a command for stopping the robot 10 according to the control parameter set by the stop method determination unit 552, in response to detection of contact between the robot 10 and the external environment by the external force detection unit 154.

As an exemplification, the stop method determination unit 552 sets a stop time T51 applied when the approach of the person OP to the robot 10 is detected by the human detection sensor 501 to be shorter than a stop time T52 applied when the approach of the person OP to the robot 10 is not detected by the human detection sensor 501. In other words, the stop method determination unit 552 sets a stop time to be T51<T52. In this case, the stop command unit 153 executes deceleration control by determining acceleration (deceleration) for stopping the robot 10 from a current speed in the stop time T51 (or T52).

In a situation where a person is approaching the robot 10, there is a high risk that the person touches not only a hand of the robot 10 but also dangerous portions such as an arm main body of the robot 10. In this regard, by performing the stop control as described above, the robot 10 is stopped in a short time in a situation where a person is approaching the robot 10, thereby further enhancing safety of the person.

### Sixth Embodiment

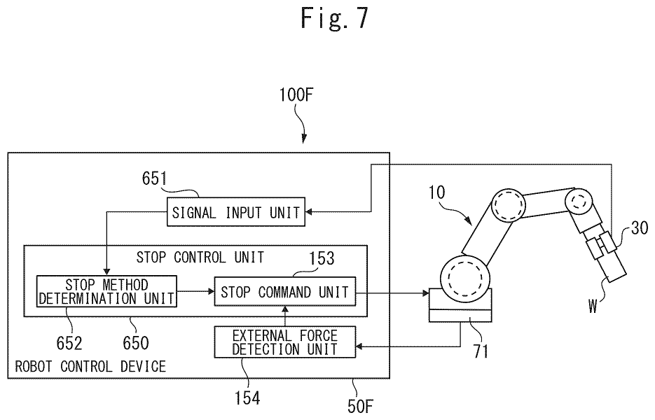

FIG. 7 illustrates an apparatus configuration of a robot system 100F including a robot control device 50F according to the sixth embodiment, and functional blocks of the robot control device 50F. As illustrated in FIG. 7, the robot system 100F includes a robot 10 and the robot control device 50F that controls the robot 10. The robot 10 is fixed to an installation floor.

In the present embodiment, the robot control device 50F is configured to dynamically switch stop control when contact between the robot 10 and an external environment is detected, according to a signal indicating an operating state (open/close state) of a hand 30 as an end effector mounted on the robot 10.

The functional blocks of the robot control device 50F illustrated in FIG. 7 are represented with a focus on such a stop control function in the robot control device 50F. The robot control device 50F includes a signal input unit 651, a stop control unit 650, and an external force detection unit 154.

A signal indicating an operating state from the hand 30 is input to the signal input unit 651. As an exemplification, the signal from the hand 30 is a signal to be turned on when the hand is actuated and closed (the hand 30 is holding a workpiece W). In other words, in the present embodiment, a signal indicating a state of the robot 10 is input to the stop control unit 650 via the signal input unit 651.

The external force detection unit 154 detects contact between the robot 10 and an external environment, based on a detected value of a force sensor 71.

The stop control unit 650 switches, depending on whether the hand 30 is closed (whether the hand 30 is holding the workpiece W), stop control for stopping the robot 10 when contact between the robot 10 and the external environment is detected by the external force detection unit 154. As a configuration for achieving such a function, the stop control unit 650 includes a stop method determination unit 652 and a stop command unit 153.

The stop method determination unit 652 switches, between a case where the hand 30 is holding the workpiece W and a case where the hand 30 is not holding the workpiece W, a type and/or a set value of a control parameter used for the stop control when contact between the robot 10 and the external environment is detected by the external force detection unit 154. The control parameter used for the stop control may include at least one of a stop time, acceleration, a jerk, a motor current, an axis torque, and a reversal distance.

The stop command unit 153 sends, to the robot 10, a command for stopping the robot 10 according to the control parameter set by the stop method determination unit 652, in response to detection of contact between the robot 10 and the external environment by the external force detection unit 154.

As an exemplification, the stop method determination unit 652 sets acceleration (deceleration) applied to the stop control when the hand 30 is holding the workpiece W (when a signal input to the signal input unit 651 is ON) to be a value smaller than acceleration (deceleration) applied to the stop control when the hand 30 is not holding the workpiece W (when a signal input to the signal input unit 651 is OFF). In this way, the robot 10 is gently stopped when the robot 10 is holding the workpiece W.

In a situation where the robot 10 performs work while holding the workpiece W, it is desirable to execute the stop control when contact between the robot 10 and the external environment is detected such that a situation where an excess load (impact) is imposed on the workpiece W and the robot 10 can be avoided. Thus, by using acceleration as a control parameter applied to the stop control, the present embodiment achieves control capable of gently stopping the robot 10 when the hand 30 is holding the workpiece W.

It should be noted that the stop method determination unit 652 may set a stop time T61 applied to the stop control when the hand 30 is holding the workpiece W to be longer than a stop time T62 applied to the stop control when the hand 30 is not holding the workpiece W. Also in this case, the robot 10 can be gently stopped when the hand 30 is holding the workpiece W.

### Seventh Embodiment

The first embodiment to the third embodiment and the sixth embodiment described above can be regarded as the configuration for dynamically switching, according to a signal indicating a state of the robot 10, stop control performed when contact between the robot 10 and an external environment is detected. Further, the fourth embodiment and the fifth embodiment can be regarded as the configuration for dynamically switching, according to a signal indicating a state of a surrounding environment of the robot 10, stop control when contact between the robot 10 and an external environment is detected. An embodiment having a configuration in which the functions described in the first embodiment to the sixth embodiment are integrated is also possible. Hereinafter, a robot control device having the function configured by integrating the functions of the robot control devices according to the first embodiment to the sixth embodiment will be described.

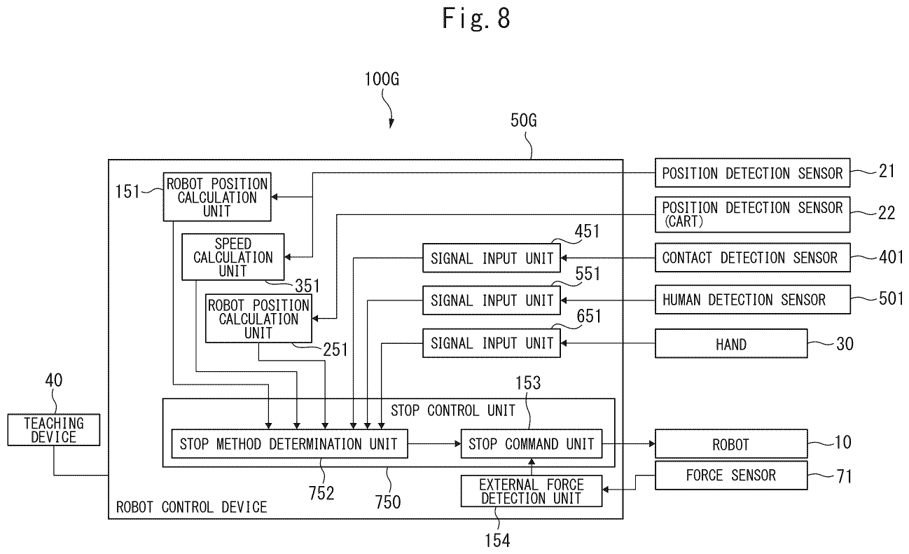

FIG. 8 is a functional block diagram of a robot system 100G including a robot control device 50G according to the seventh embodiment. In FIG. 8, the same components as those in the first to sixth embodiments are provided with the same reference signs. It should be noted that an apparatus configuration of the robot system 100G is equivalent to the configuration illustrated in FIG. 1, for example, and various sensors (for example, the human detection sensor 501) are arranged as illustrated in the corresponding embodiment.

As illustrated in FIG. 8, the robot system 100G includes the robot 10 and the robot control device 50G that controls the robot 10. A teaching device 40 may be connected to the robot control device 50G. The robot control device 50G is configured to include a plurality of the input/output interfaces 53 (FIG. 2) to which signals from various sensors can be input. Therefore, as illustrated in FIG. 8, each of a signal from the position detection sensor 21 of the robot 10, a signal from the position detection sensor 22 disposed on the cart 81 when the robot 10 is mounted on the cart 81, a signal from the contact detection sensor 401 attached to the robot 10, a signal from the human detection sensor 501, and a signal from the hand 30 mounted on the robot 10 can be input to the robot control device 50G according to the actual apparatus configuration of the robot system 100G.

The teaching device 40 is used for performing teaching of the robot 10 or various types of setting related to teaching. The teaching device 40 may have a configuration as a general computer in which a memory (such as a ROM, a RAM, and a non-volatile memory), a display unit, an operation unit, an input/output interface, and the like are connected to a processor via a bus.

The robot control device 50G includes signal input units 451, 551, and 651, the robot position calculation unit 151, the robot position calculation unit 251, the speed calculation unit 351, a stop control unit 750, and the external force detection unit 154. The stop control unit 750 includes a stop method determination unit 752 and the stop command unit 153.

A signal from the position detection sensor 21 is input to the robot position calculation unit 151 and the speed calculation unit 351. A signal from the position detection sensor 22 is input to the robot position calculation unit 251. A signal from the contact detection sensor 401 is input to the stop method determination unit 752 via the signal input unit 451. A signal from the human detection sensor 501 is input to the stop method determination unit 752 via the signal input unit 551. A signal from the hand 30 is input to the stop method determination unit 752 via the signal input unit 651.

The stop method determination unit 752 can switch stop control, based on any of
(1) a signal being input from the robot position calculation unit 151 and indicating that the robot 10 is within the set region 90,
(2) a signal being input from the robot position calculation unit 251 and indicating that the robot 10 is within the set region 91,
(3) a signal being input from the speed calculation unit 351 and indicating that a speed of a predetermined movable portion of the robot 10 is equal to or greater than a predetermined speed,
(4) a signal being input from the signal input unit 451 and indicating that contact of a person is detected by the contact detection sensor 401,
(5) a signal being input from the signal input unit 551 and indicating that the approach of a person is detected by the human detection sensor 501, and
(6) a signal being input from the signal input unit 651 and indicating that the hand 30 is closed and holding the workpiece W,
   when contact between the robot 10 and an external environment is detected by the external force detection unit 154.

When the stop method determination unit 752 is operated by (1) described above, the stop method determination unit 752 switches the stop control according to the operation described in the first embodiment. When the stop method determination unit 752 is operated by (2) described above, the stop method determination unit 752 switches the stop control according to the operation described in the second embodiment. When the stop method determination unit 752 is operated by (3) described above, the stop method determination unit 752 switches the stop control according to the operation described in the third embodiment. When the stop method determination unit 752 is operated by (4) described above, the stop method determination unit 752 switches the stop control according to the operation described in the fourth embodiment. When the stop method determination unit 752 is operated by (5) described above, the stop method determination unit 752 switches the stop control according to the operation described in the fifth embodiment. When the stop method determination unit 752 is operated by (6) described above, the stop method determination unit 752 switches the stop control according to the operation described in the sixth embodiment.

The stop method determination unit 752 may be configured to allow a user to set which of the operations (1) to (6) described above the stop method determination unit 752 should follow, via a setting screen displayed on a display unit (such as a touch panel) of the teaching device 40, for example. In this case, the user can select which of the operations (1) to (6) described above the robot control device 50G should follow, according to an actual operating environment of the robot system 100G.

The stop command unit 153 generates, according to a control parameter set by the stop method determination unit 752, a command for stopping the robot 10 when contact between the robot 10 and the external environment is detected by the external force detection unit 154, and sends the command to the robot 10.

According to the configuration of the robot system 100G described above, a user can set the robot control device 50G to operate according to any of the functions of the robot control devices 50, 50B, 50C, 50D, 50E, and 50F of the first embodiment to the sixth embodiment described above.

All of the robot control devices according to the embodiments described above can be expressed as a “robot control device that controls a robot, and includes: an external force detection unit that detects an external force acting on the robot; and a stop control unit that switches, according to a signal indicating a state of the robot or a state of a surrounding environment of the robot, stop control for stopping the robot when an external force equal to or greater than a predetermined value is detected by the external force detection unit”.

According to the configuration of each of the embodiments described above, more appropriate stop control can be achieved by dynamically switching the stop control according to conditions when contact between a robot and an external environment is detected and the robot is stopped.

The present invention has been described above by using the typical embodiments, but it will be understood by those of ordinary skill in the art that changes, other various changes, omission, and addition may be made in each of the embodiments described above without departing from the scope of the present invention.

A signal indicating a state of a robot may include various signals indicating a state of a robot, a tool mounted on a robot, and the like in addition to the examples in the embodiments described above. Further, a signal indicating a surrounding environment of a robot may include various signals indicating a state of an environment around a robot in addition to the examples in the embodiments described above.

The robot in each of the embodiments described above is assumed to be mainly a cooperative robot, but the configuration of each of the embodiments described above can also be applied to a case where a normal robot other than the cooperative robot is used.

The functional block in the functional block diagram of the robot control device indicated in each of the embodiments described above may be achieved by executing various types of software stored in a storage device by the processor of the robot control device, or may be achieved by a configuration in which hardware such as an application specific integrated circuit (ASIC) is a main body.

### REFERENCE SIGNS LIST

10 Robot
11 Base
21, 22 Position detection sensor
30 Hand
40 Teaching device
50, 50B, 50C, 50D, 50E, 50F, 50G Robot control device
51 Processor
52 Memory
53 Input/output interface
54 Operation unit
71 Force sensor
80 Table
81 Cart
90, 91 Set region
100, 100B, 100C, 100D, 100E, 100F, 100G Robot system
150 Stop control unit
151 Robot position calculation unit
152 Stop method determination unit
153 Stop command unit
154 External force detection unit
250 Stop control unit
251 Robot position calculation unit
252 Stop method determination unit
350 Stop control unit
351 Speed calculation unit
352 Stop method determination unit
401 Contact detection sensor
450 Stop control unit
451 Signal input unit
452 Stop method determination unit
501 Human detection sensor
550 Stop control unit
551 Signal input unit
552 Stop method determination unit
650 Stop control unit
651 Signal input unit
652 Stop method determination unit
750 Stop control unit
752 Stop method determination unit

1. A robot control device configured to control a robot, comprising:
an external force detection unit configured to detect an external force acting on the robot; and
a stop control unit configured to switch, according to a signal indicating a state of the robot or a state of a surrounding environment of the robot, stop control for stopping the robot when an external force equal to or greater than a predetermined value is detected by the external force detection unit.

2. The robot control device according to claim 1, further comprising
a robot position calculation unit configured to calculate a position of the robot, based on an output from a position detection sensor provided on the robot, and output, as a signal indicating a state of the robot, a first signal indicating whether the calculated position of the robot is within a first set region being preset, wherein
the stop control unit switches the stop control according to the first signal.

3. The robot control device according to claim 2, wherein,
in a case where an external force equal to or greater than the predetermined value is detected and the robot is stopped, the stop control unit sets a stop time for stopping the robot when the position of the robot is within the first set region to be shorter than a stop time for stopping the robot when the position of the robot is outside the first set region.

4. The robot control device according to claim 1, wherein
the robot is mounted on a movable cart,
the robot control device further comprises a robot position calculation unit configured to calculate a position of the robot being movable together with the cart, based on an output from a position detection sensor for detecting a position of the cart, and output, as a signal indicating a state of the robot, a second signal indicating whether the calculated position of the robot is within a second set region being preset, and
the stop control unit switches the stop control according to the second signal.

5. The robot control device according to claim 4, wherein,
in a case where an external force equal to or greater than the predetermined value is detected and the robot is stopped, the stop control unit sets a stop time for stopping the robot when the position of the robot is within the second set region to be shorter than a stop time for stopping the robot when the position of the robot is outside the second set region.

6. The robot control device according to claim 2, wherein
the stop control unit reverses the robot by a predetermined reversal distance after the stop control unit stops the robot by the stop control.

7. The robot control device according to claim 1, further comprising
a speed calculation unit configured to calculate a speed of a predetermined movable portion of the robot, based on an output from a sensor provided on the robot, and output, as a signal indicating a state of the robot, a third signal indicating whether the calculated speed of the predetermined movable portion is equal to or greater than a predetermined speed value, wherein the stop control unit switches the stop control according to the third signal.

8. The robot control device according to claim 7, wherein,
in a case where an external force equal to or greater than the predetermined value is detected and the robot is stopped, the stop control unit sets a stop time for stopping the robot when the speed of the robot is equal to or greater than the predetermined speed value to be longer than a stop time for stopping the robot when the speed of the robot is less than the predetermined speed value.

9. The robot control device according to claim 1, further comprising
a first signal input unit to which a fourth signal from a contact detection sensor attached to a specific portion of the robot is input, wherein
the fourth signal is input to the stop control unit via the first signal input unit, and
the stop control unit switches the stop control according to a state of a surrounding environment of the robot being indicated as the fourth signal.

10. The robot control device according to claim 9, wherein,
in a case where an external force equal to or greater than the predetermined value is detected and the robot is stopped, the stop control unit sets a stop time for stopping the robot when contact with the specific portion is detected by the contact detection sensor to be shorter than a stop time for stopping the robot when contact with the specific portion is not detected by the contact detection sensor.

11. The robot control device according to claim 1, further comprising
a second signal input unit to which a fifth signal from a human detection sensor disposed in a workspace where the robot is present is input, wherein
the fifth signal is input to the stop control unit via the second signal input unit, and
the stop control unit switches the stop control according to a state of a surrounding environment of the robot being indicated as the fifth signal.

12. The robot control device according to claim 11, wherein,
in a case where an external force equal to or greater than the predetermined value is detected and the robot is stopped, the stop control unit sets a stop time for stopping the robot when approach of a person to the robot is detected by the human detection sensor to be shorter than a stop time for stopping the robot when approach of a person to the robot is not detected by the human detection sensor.

13. The robot control device according to claim 1, further comprising
a third signal input unit to which a sixth signal indicating an operating state of a hand mounted on the robot is input, wherein
the sixth signal is input to the stop control unit via the third signal input unit, and the stop control unit switches the stop control according to a state of the robot being indicated as the sixth signal.

14. The robot control device according to claim 13, wherein,
in a case where an external force equal to or greater than the predetermined value is detected and the robot is stopped, the stop control unit sets deceleration for stopping the robot when the sixth signal indicates that the hand is closed to be a value smaller than deceleration for stopping the robot when the sixth signal indicates that the hand is open.

15. The robot control device according to claim 1, wherein
the stop control unit switches the stop control by changing a type and/or a set value of a control parameter including at least one or more of a stop time, acceleration, a jerk, a motor current, an axis torque, and a reversal distance.
